(19) United States
(12) Patent Application Publication
(10) Pub. No.: US 2006/0212455 A1
(43) Pub. Date: Sep. 21, 2006

(54) Method and system for organizing image files based upon workflow

(75) Inventors: Benjamin L. Perry, Seattle, WA (US); David R. Parlin, Redmond, WA (US); Eric W. Doerr, Redmond, WA (US); James H. Wang, Bellevue, WA (US); Michael J. Gilmore, Bothell, WA (US); Scott E. Dart, Redmond, WA (US); Hong Li, Sammamish, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/079,983

(22) Filed: Mar. 15, 2005

(51) Int. Cl. G06F 7/00

(52) U.S. Cl. 707/100

(57) ABSTRACT

Methods and systems that permit a user to associate metadata representing one or more workflow-related actions with an image file are provided. Workflow-related actions describe one or more actions which may be undertaken with respect to the associated image file. For instance, workflow-related actions may include, by way of example only, printing, editing, reviewing, sharing, deleting, and the like. Once associated with metadata representing one or more workflow-related actions, the image file may be retrieved based upon a query for at least one of the workflow-related actions. If more than one workflow-related action is represented in the metadata associated with the image file, the image file may be retrieved based upon a query for each workflow-related action individually or multiple workflow-related actions concurrently.

### CROSS-REFERENCE TO RELATED APPLICATIONS

Not Applicable.

### STATEMENT REGARDING FEDERALLY SPONSORED RESEARCH OR DEVELOPMENT

Not Applicable

### TECHNICAL FIELD

The present invention relates to computing environments. More particularly, embodiments of the present invention relate to methods for organizing image files, e.g., digital photographs, video files, and the like, based upon workflow. Workflow may include, by way of example only, specific action items that a particular user may desire or intend to take with respect to the image file(s) being organized.

### BACKGROUND OF THE INVENTION

Conventional image file organization applications permit the organization of image files, in part, based upon metadata associated with the subject matter of the file. For instance, photographs may be organized based upon objective metadata, e.g., the date the photograph was taken, and/or based upon subjective metadata, e.g., a keyword associated with the photograph. The subjective metadata utilized in such applications is typically representative of a characteristic of the photograph that is static, that is, a characteristic that does not change over time. For instance, a photograph may be associated with the keyword “sunset” indicating that it is a photograph of a sunset, a characteristic of the photograph that will not change over time. The photograph may subsequently be retrieved as the result of a query for any of the metadata associated therewith.

Such conventional image file organization applications have a number of drawbacks. For instance, as taking and storing digital photographs has become more prolific in recent years, it has become increasingly important that photograph files be organized in a manner that permits efficient treatment thereof. However, conventional photograph organization applications do not support efficient treatment in that organization of photographs based upon subjective metadata that may change over time, is not facilitated. By way of example only, subjective metadata that may change over time may include an action a user desires or intends to undertake with respect to the photograph that, once taken, need no longer be associated therewith.

Accordingly, a method which facilitates the association of subjective metadata that is dynamic, that is, that is capable of changing over time, with an image file would be advantageous. Further, a method which facilitates efficient treatment of image files for organization would be advantageous.

### BRIEF SUMMARY OF THE INVENTION

Embodiments of the present invention relate to methods for organizing image files based upon workflow. In one such embodiment, the method includes receiving at least one image file, e.g., a photograph, obtaining metadata to be associated with the at least one image file, the metadata representing a workflow-related action, and storing the at least one image file in association with the metadata. The metadata may be received, for instance, via user input, or automatically determined. If desired, the method may further include processing a query indicative of the workflow-related action and displaying the at least one image file in response thereto.

Additionally, the present invention relates to computer-readable media having computer-executable instructions for performing the methods disclosed herein.

Further embodiments of the present invention relate to computer-readable media having stored thereon a data structure. In one such embodiment, the data structure comprises a first field containing data representing an image file, e.g., a photograph, and a second field containing metadata representing a workflow-related action capable of being associated with the data representing the image file.

Still further embodiments of the present invention relate to a user interface for organizing image files, e.g., photographs, based upon workflow. In one such embodiment, the user interface includes an image file indicator display area configured to display a selectable image file indicator, e.g., a thumbnail, and a workflow-related indicator display area configured to display a selectable workflow-related indicator capable of being associated with the selectable image file indicator. If desired, the user interface may further include a control (e.g., a push button, scroll bar, pull-down menu, drop-down menu, or the like) for associating the selectable workflow-related indicator with the selectable image file indicator. Further, the image file indicator display area may be further configured to display the selectable image file indicator in association with the selectable workflow-related indicator.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a flow diagram showing a method for organizing image files into collections based upon workflow-related metadata, in accordance with an embodiment of the present invention;

FIG. 3 is an illustrative screen display of an exemplary user interface for manually associating metadata representing one or more workflow-related actions with a photograph utilizing a preview pane, in accordance with an embodiment of the present invention;

FIG. 4 is an illustrative screen display of an exemplary user interface for manually associating metadata representing one or more workflow-related actions with a photograph utilizing a drop-down menu from a toolbar, in accordance with an embodiment of the present invention;

FIG. 5 is an illustrative screen display of an exemplary user interface for manually associating metadata representing one or more workflow-related actions with a photograph utilizing a context menu, in accordance with an embodiment of the present invention;

FIG. 6 is an illustrative screen display of an exemplary user interface for accessing a ‘Label Painter’ dialog box from which metadata representing one or more workflow-related actions may be associated with a photograph, in accordance with an embodiment of the present invention;

FIG. 7 is an illustrative screen display of an exemplary user interface illustrating a ‘Label Painter’ dialog box for associating metadata representing one or more workflow-related actions with a photograph, which dialog box may be accessible as indicated in FIG. 6, in accordance with an embodiment of the present invention;

FIG. 8 is an illustrative screen display of an exemplary properties dialog box for associating metadata representing one or more workflow-related actions with a photograph, in accordance with an embodiment of the present invention;

FIG. 9 is an illustrative screen display of an exemplary ‘Label Editor’ dialog box for associating metadata representing one or more workflow-related actions with a photograph, in accordance with an embodiment of the present invention;

FIG. 10 is an illustrative screen display of an exemplary user interface for querying for a particular photograph collection based upon workflow-related metadata, in accordance with an embodiment of the present invention;

FIG. 11 is an illustrative screen display showing an ‘Edit Flags’ dialog box for editing flags and/or labels associated with workflow-related metadata, in accordance with an embodiment of the present invention; and

FIG. 12 is a block diagram of an illustrative data structure having an image file data field and a workflow-related metadata field, in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide methods and systems that permit a user to associate metadata representing one or more workflow-related actions with at least one image file, e.g., at least one photograph. The term “workflow-related action”, as used herein, describes one or more specific actions (or a category of actions) which a particular user may desire or intend to undertake with respect to an associated image file. For instance, workflow-related actions may include, by way of example only, printing, editing, reviewing, sharing, deleting, and the like.

Once associated with metadata representing one or more workflow-related actions, an image file, e.g., a photograph, may be retrieved based upon a query for at least one of the associated workflow-related actions. If more than one workflow-related action is represented in the metadata associated with a particular image file, the file may be retrieved based upon a query for each workflow-related action individually or multiple workflow-related actions concurrently.

Workflow-related actions are dynamic by nature, that is, they are likely to change over time as actions are undertaken with respect to a particular image file. Thus, the methods and systems of the present invention facilitate the organization of image files based upon dynamic subjective metadata. Such organization supports the efficient treatment of image file collections, as more fully described below.

Having briefly described an overview of the present invention, an exemplary operating environment for the present invention is described below.

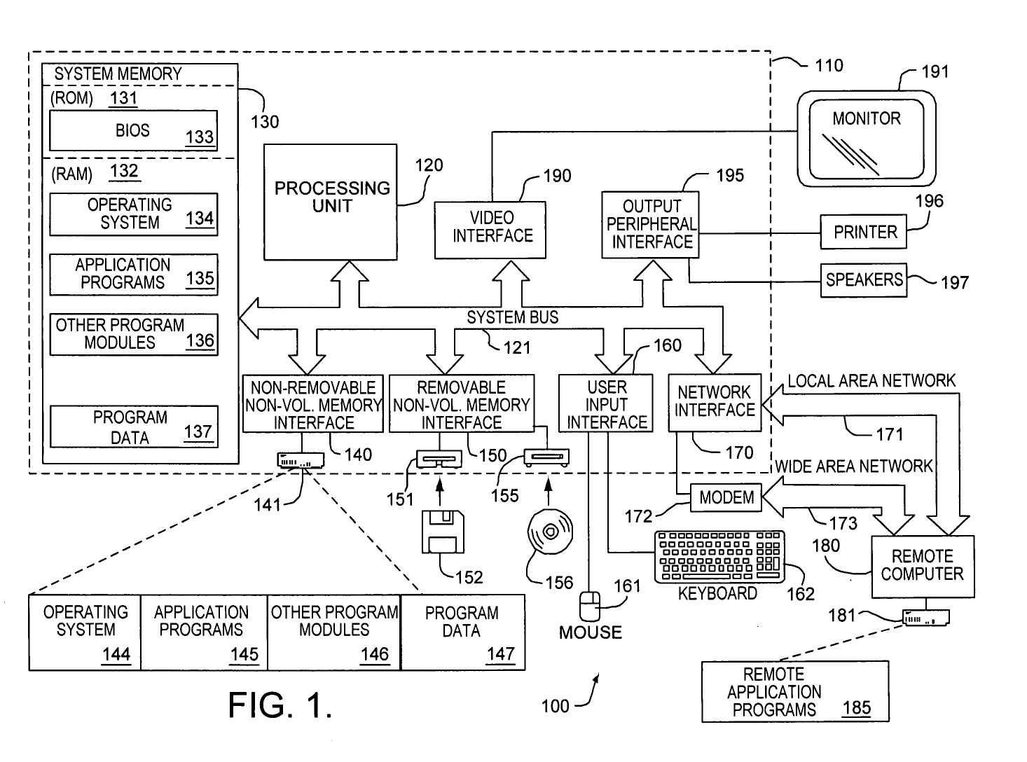

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

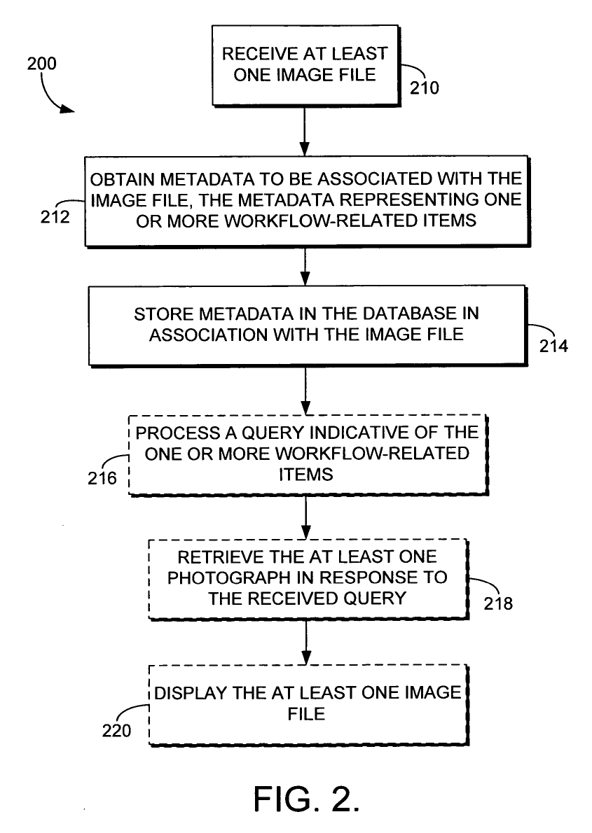

As previously mentioned, in one embodiment, the present invention relates to a method for organizing image files (e.g., photographs, video files, and the like) based upon metadata containing one or more workflow-related actions. Turning to FIG. 2, a flow diagram is illustrated which shows a method 200 for organizing image files in accordance with an embodiment of the present invention. Initially, as indicated at block 210, at least one image file is received. By way of example only, if the at least one image file is a photograph, the photograph may be uploaded from a camera, downloaded from another application, or received by any other means known to those of ordinary skill in the art. Oftentimes, image files include objective metadata associated therewith, such objective metadata being indicative of, for example, the date and/or time a photograph was taken, a default caption or photograph title (e.g., IMG_{—}0001), or the like. If present, this objective metadata may be obtained or determined and stored in association with the image file upon receipt.

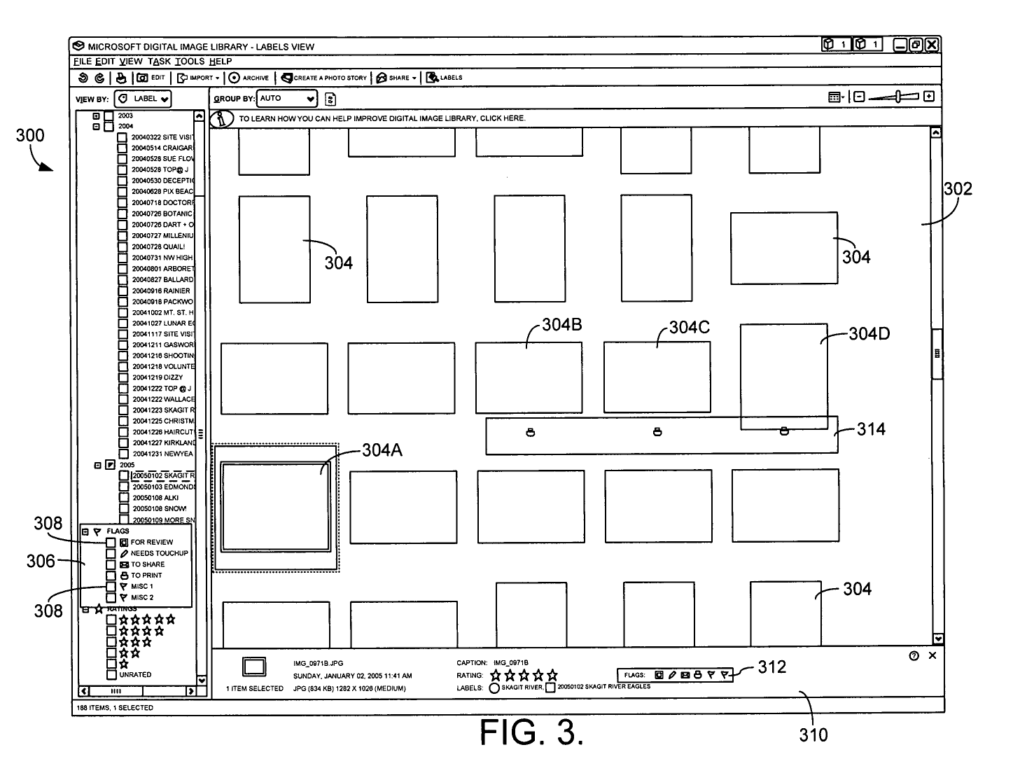

Subsequently, subjective metadata to be associated with the image file is obtained, as indicated at block 212, the subjective metadata representing one or more workflow-related actions. Workflow-related actions may include specific actions a user may desire or intend to take with respect to a received image file and may include, by way of example only, printing, editing, reviewing, sharing, deleting, and the like. Such subjective metadata may be obtained in a variety of different ways. First, the subjective metadata may be received based upon manual user input. In this instance, a user may select one or more image files to which he/she desires to add additional metadata, e.g., the user may select one or more thumbnail indicators of image files from an image file indicator display area, as more fully described below, and manually associate the subjective metadata therewith. This embodiment of the present invention may be more readily understood with reference to FIGS. 3-9 and the following examples. It will be understood and appreciated by those of ordinary skill in the art that the drawing figures and examples are merely illustrative and are not intended to limit the scope of the invention in any way.

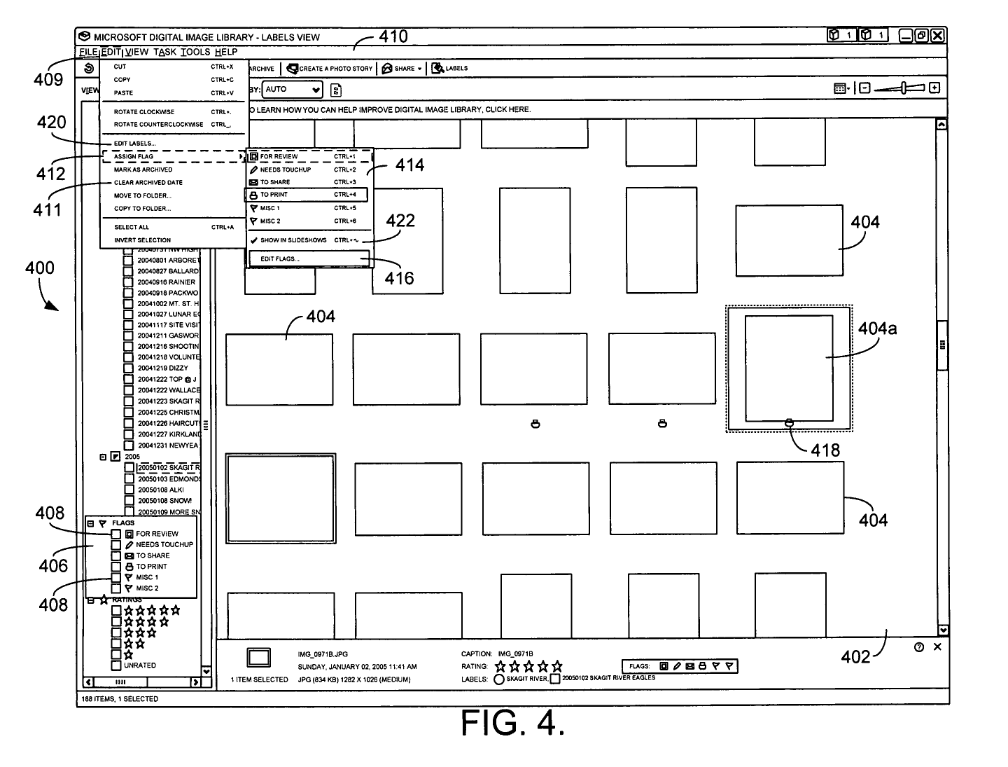

With reference to FIG. 3, a user interface for manually associating metadata representing one or more workflow-related actions with at least one photograph is illustrated and designated generally as reference numeral 300. The user interface 300 includes an image file indicator display area 302 configured to display one or more selectable image file indicators 304, e.g., thumbnail indicators of the photographs. It will be understood and appreciated by those of ordinary skill in the art that while the user interface 300 is illustrative of manually associating metadata with one or more photographs, the present invention is not limited to this file format. A similar user interface having complementary illustrated features may be utilized for other image file formats (e.g., video files, and the like) and all such variations are contemplated to be within the scope of the present invention. A similar statement may be made with regard to the screen displays of each of FIGS. 4-9.

The user interface 300 of FIG. 3 further includes a workflow-related indicator display area 306 configured to display one or more selectable workflow-related indicators 308. In the illustrated embodiment, there are six selectable workflow-related indicators 308 shown located within a node of a ‘View By’ hierarchical tree structure, the node being designated by the term ‘Flags’. The six selectable workflow-related indicators shown are ‘For Review’, ‘Needs Touchup’, ‘To Share’, ‘To Print’, ‘Misc 1’, and ‘Misc 2’. The ‘For Review’ indicator may be applied to one or more photographs that, for instance, a user desires or intends to review prior to taking any further action. The ‘Needs Touchup’ indicator may be applied to one or more photographs that, for instance, a user desires or intends to edit. The ‘To Share’ indicator may be applied to one or more photographs that, for instance, a user desires or intends to email to another individual. The ‘To Print’ indicator may be applied to those photographs that a user desires or intends to print. The ‘Misc 1’ and ‘Misc 2’ indicators represent flags or indicators that may be defined by a user. For instance, a user may desire to flag one or more photographs for deletion or for downloading to an external storage medium at a later date. In such instances, the user may assign one of the miscellaneous indicators to the photographs and, if desired, may even rename the label given to the indicator, as more fully described below.

It will be understood and appreciated by those of ordinary skill in the art that the workflow-related indicators 308 shown are provided by way of example only and are not intended to limit the scope of the invention in any way.

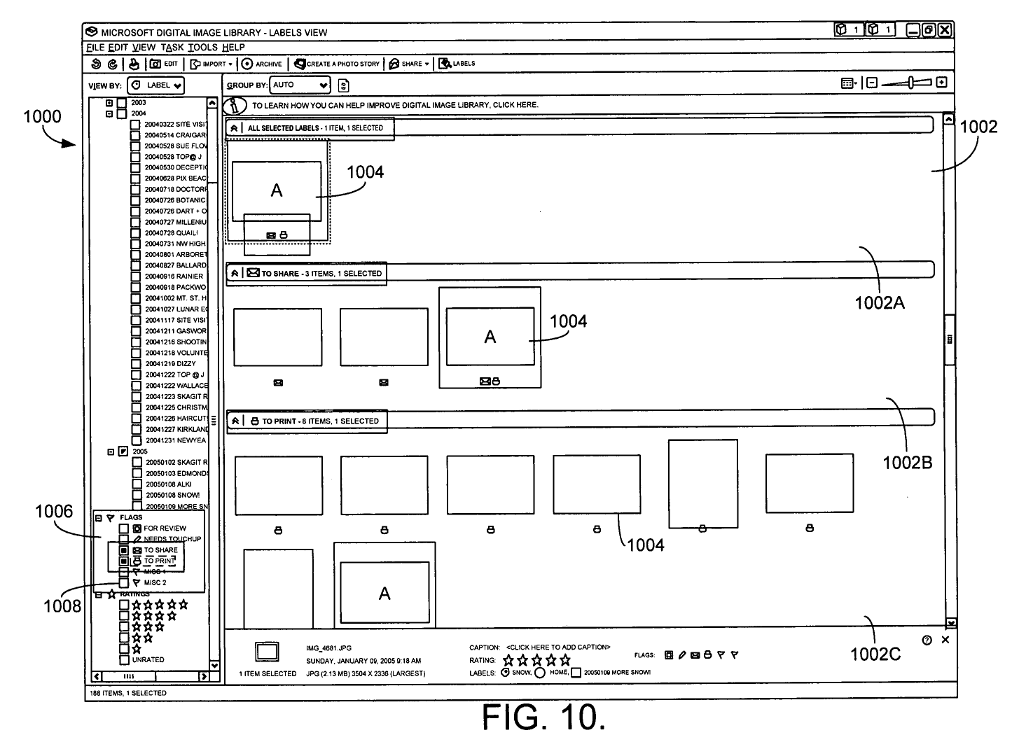

The selectable workflow-related indicators 308, in the illustrated embodiment, include both a flag and a label. For instance, one of the selectable workflow-related indicators 308 includes a flag that resembles a schematic drawing of a printer and the label “To Print”. The workflow-related indicators 308 shown in the user interface 300 of FIG. 3 may be utilized to query flags for one or more actions a user desires (or has indicated an intention) to perform, as more fully described below with reference to FIG. 10.

The user interface 300 additionally includes a preview pane 310 having a second workflow-related display area 312 therein. The second workflow-related display area 312 illustrates only the flags themselves (without the corresponding labels), which flags are the same as those illustrated in the workflow-related display area 306.

In order to assign one or more flags to a particular image file (or files), that is, to manually associate metadata representing one or more workflow-related actions to a particular image file (or files), a user may first select one or more image files by selecting the thumbnail(s) associated therewith from the image file indicator display area 302. Such selection of the thumbnail(s) may be accomplished by any means known to those of ordinary skill in the art, for instance, hovering a mouse indicator over the thumbnail and selecting a button thereon. Once one or more thumbnails have been selected, an indication that the image files (e.g., photograph(s)) associated with the thumbnail(s) has been selected is displayed in association with the thumbnail. For instance, in the illustrated embodiment, a user has selected photograph thumbnail 304A and a dashed line is shown surrounding the thumbnail perimeter to indicate that it has been selected. Subsequently, the user may select one or more of the flags shown in the second workflow-related display area 312. Again, such selection may be accomplished by any means known to those of ordinary skill in the art.

In one embodiment, once one or more flags have been associated with or assigned to a particular image file, the flag(s) may be displayed in association with the thumbnail, as indicated by flag overlay 314. The illustrated flag overlay 314 indicates that each of thumbnails 304B, 304C and 304D have been associated with the flag “To Print”.

With reference to FIG. 4, a second user interface for manually associating metadata representing one or more workflow-related actions is shown and designated generally as reference numeral 400. The user interface 400 includes an image file indicator display area 402 configured to display one or more selectable image file indicators 404, and a workflow-related indicator display area 406 configured to display one or more selectable workflow-related indicators 408. As with the user interface 300 of FIG. 3, the workflow-related indicators 408 of FIG. 4 may be utilized to query flags for one or more workflow-related actions a user desires to perform, as more fully described below.

Flags indicative of metadata representing one or more workflow-related actions may be associated with a particular image file by way of a control, for instance, a push button, scroll bar, pull-down menu, drop-down menu, or the like. The user interface 400 of FIG. 4 illustrates one example of a control and shows that flags indicative of metadata representing one or more workflow-related actions may be associated with a particular image file by way of a function accessible from the ‘Edit’ drop-down menu. In this instance, a user may select an image file indicator (e.g., a photograph thumbnail) and subsequently select the ‘Edit’ option from the toolbar followed by an ‘Assign Flag’ option from the resulting drop-down menu. The user may then be presented with the flags and associated labels available for association with the image file. Selection of one or more of the flags and/or associated labels associates the metadata representing the corresponding workflow-related action with the image file associated with the selected thumbnail.

Thus, in the illustrated embodiment, a user has selected a particular photograph thumbnail, 404A, and subsequently selected the ‘Edit’ option 409 from the toolbar 410. Selection of the ‘Edit’ option caused display of a drop-down menu 411 having an ‘Assign Flag’ option 412 thereon. Selection of the ‘Assign Flag’ option caused display of a second workflow-related indicator display area 414 illustrating the flags that are available for association with the selected photograph, that is, the photograph associated with thumbnail 404A.

It should be noted that in the illustrated embodiment, the dashed line surrounding the ‘For Review’ flag and label indicates that the user is about to select this flag for association with the selected photograph (the photograph associated with thumbnail 404A). However, the user interface 400 shown may additionally be utilized to indicate which flags are already assigned to a particular image file (e.g., photograph). Thus, the solid line surrounding the ‘To Print’ flag and label indicates that the photograph associated with thumbnail 404A has already been flagged ‘To Print’. This is verified by the flag 418 shown in association with the thumbnail 404A in the image file indicator display area 402.

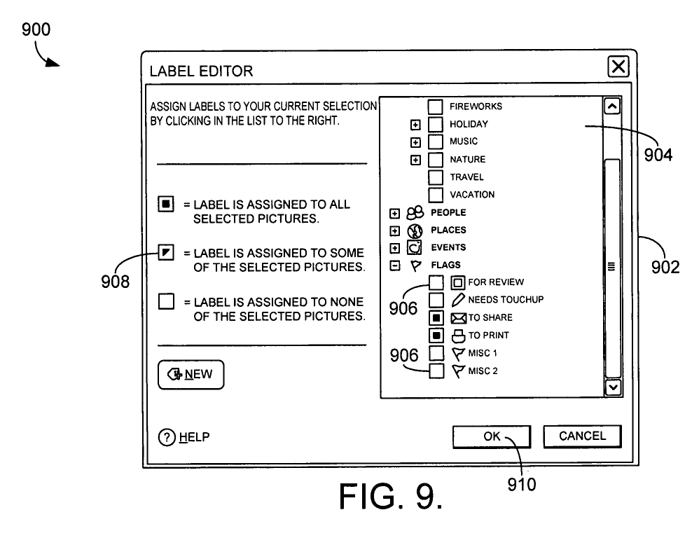

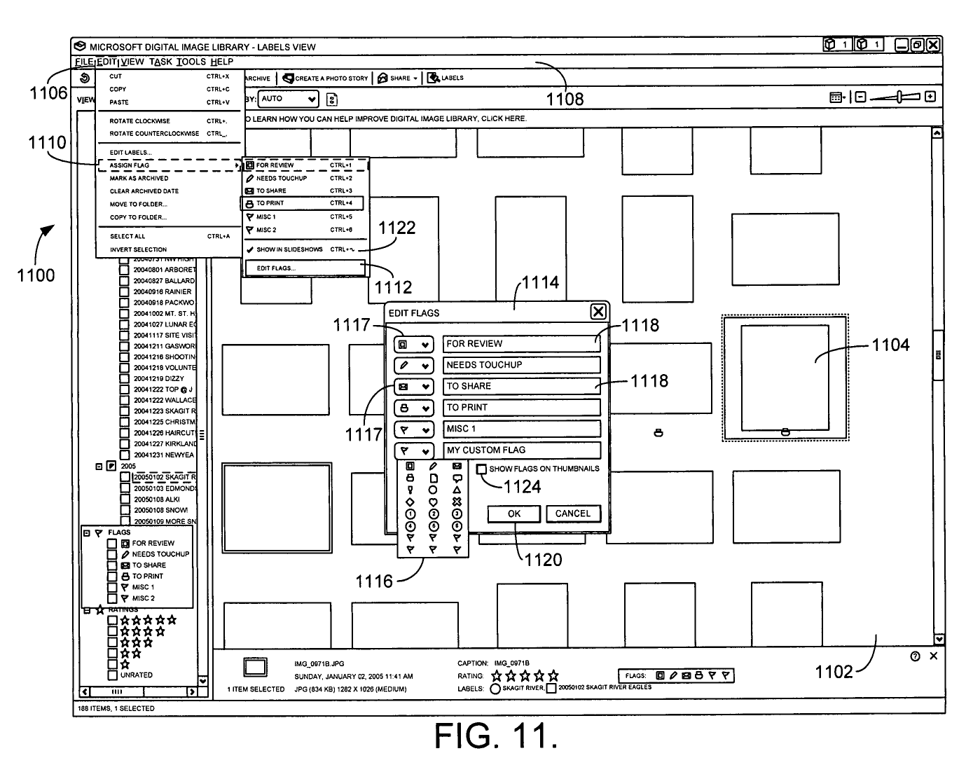

It should be further noted that the workflow-related indicator display area 414 additionally includes an option entitled ‘Edit Flags . . . ’ 416, selection of which permits a user to edit the flags and the associated labels, as more fully described below with reference to FIG. 11. Further, the ‘Edit’ drop-down menu 411 includes an option entitled ‘Edit labels . . . ’ 420, selection of which permits a user to view and edit those flags that are associated with one or more particular image files, as more fully described below with reference to FIG. 9.

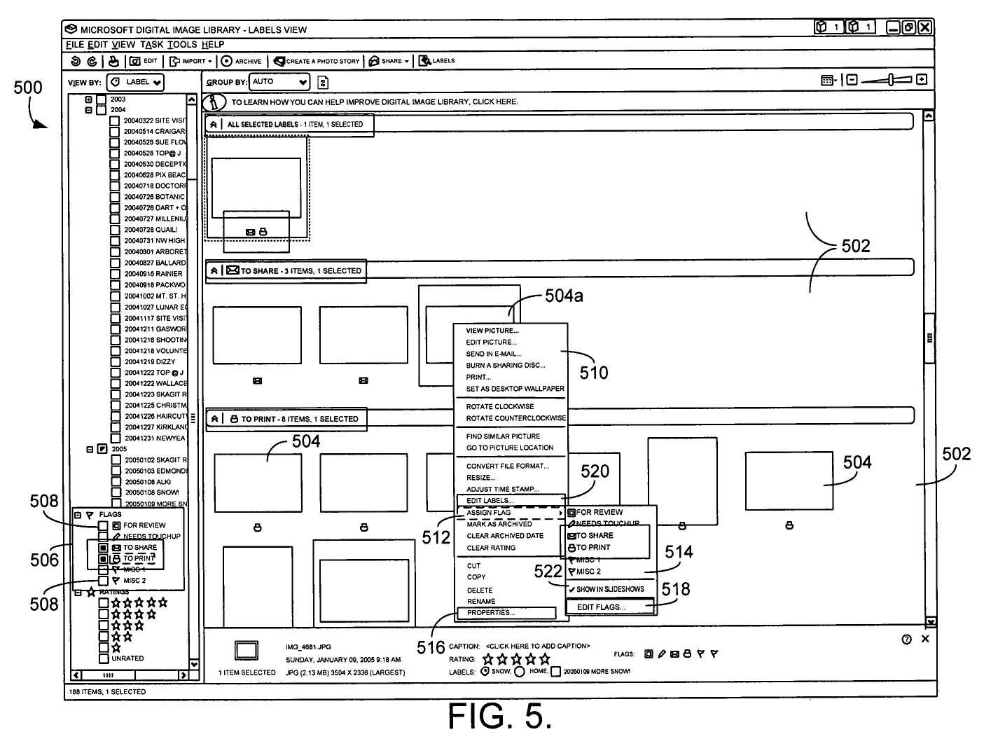

Turning now to FIG. 5, a third user interface for manually associating metadata representing one or more workflow-related actions is shown and designated generally as reference numeral 500. The user interface 500 includes an image file indicator display area 502 configured to display one or more selectable image file indicators 504, and a workflow-related indicator display area 506 configured to display one or more selectable workflow-related indicators 508. As with the user interface 300 of FIG. 3, the workflow-related indicators 508 of FIG. 5 may be utilized to query flags for one or more workflow-related actions a user desires or intends to perform with regard to one or more image files, as more fully described below with reference to FIG. 10. Note that the image file indicator display area 502 is segregated into a plurality of different display sections, the significance of which is more fully described below with reference to FIG. 10.

The user interface 500 of FIG. 5 illustrates another example of a control and shows that flags indicative of metadata representing one or more workflow-related actions may be associated with a particular image file by way of a function accessible from a context menu that is displayed when the appropriate function is applied to a selected image file, for instance, when the right-hand button of a conventional mouse is selected while the mouse pointer is hovering over the desired image file indicator. In this instance, a user may select a photograph thumbnail and subsequently apply the appropriate function to cause display of the context menu 510. The user will then be presented with the flags and associated labels available for association with the photograph. Selection of one or more of the flags and/or associated labels will associate the metadata representing the corresponding workflow-related action with the photograph associated with the selected thumbnail.

Thus, in the illustrated embodiment, a user has selected a particular photograph thumbnail, 504A, and subsequently applied the appropriate function to cause display of the context menu 510. The context menu 510 includes an ‘Assign Flag’ option 512 thereon. The user has selected the ‘Assign Flag’ option 512 causing display of a second workflow-related indicator display area 514 illustrating the flags that are available for association with the selected photograph, that is, the photograph associated with thumbnail 504A.

It should be noted that in the illustrated embodiment, the solid line surrounding the ‘To Share’ and ‘To Print’ flags indicates that the photograph associated with thumbnail 504A has already be flagged ‘To Share’ and ‘To Print’. Thus, the user interface 500 shown may additionally be utilized to indicate which flags are already assigned to a particular image file.

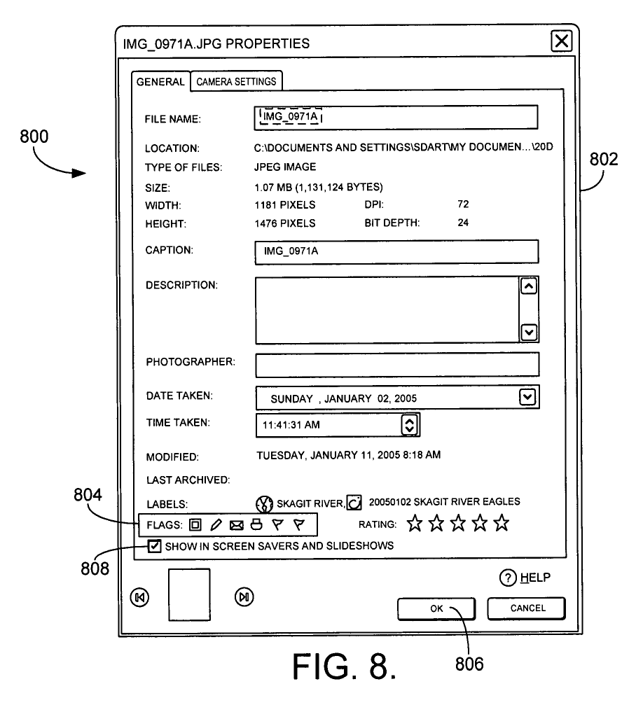

It should be further noted that in the illustrated embodiment, the context menu 510 includes a ‘Properties . . . ’ option 516, selection of which may cause display of a properties dialog box fore viewing and modifying flags assigned to a particular image file, as more fully described below with reference to FIG. 8. Further, the second workflow-related indicator display area 514 includes an option entitled ‘Edit Flags . . . ’ 518, selection of which permits a user to edit the flags and associated labels associated with a particular image file, as more fully described below with reference to FIG. 11. Still further, the context menu 510 includes an option entitled ‘Edit labels . . . ’ 520, selection of which permits a user to view and edit the flags that are associated with one or more particular image files, as more fully described below with reference to FIG. 9.

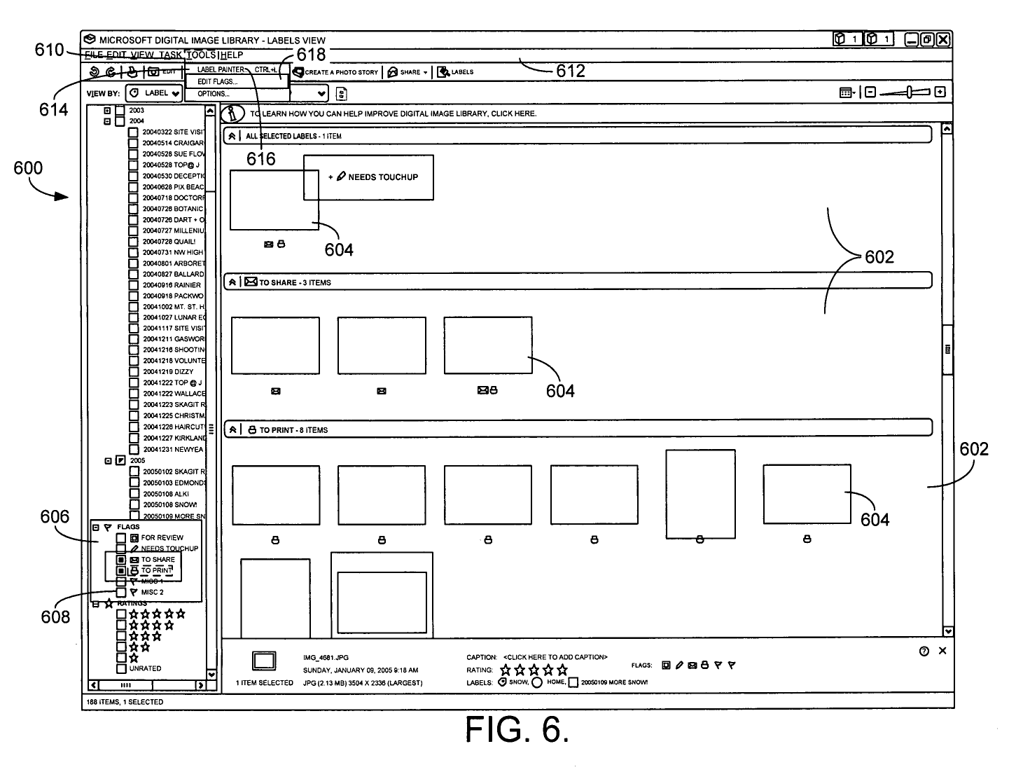

With reference to FIG. 6, an additional user interface for manually associating metadata representing one or more workflow-related actions is shown and designated generally as reference numeral 600. The user interface 600 includes an image file indicator display area 602 configured to display one or more selectable image file indicators 604, and a workflow-related indicator display area 606 configured to display one or more selectable workflow-related indicators 608. As with the user interface 300 of FIG. 3, the workflow-related indicators 608 of FIG. 6 may be utilized to query flags for one or more workflow-related actions a user desires or intends to perform, as more fully described below. Note that the image file indicator display area 602 is segregated into a plurality of different display sections, the significance of which is more fully described below with reference to FIG. 10.

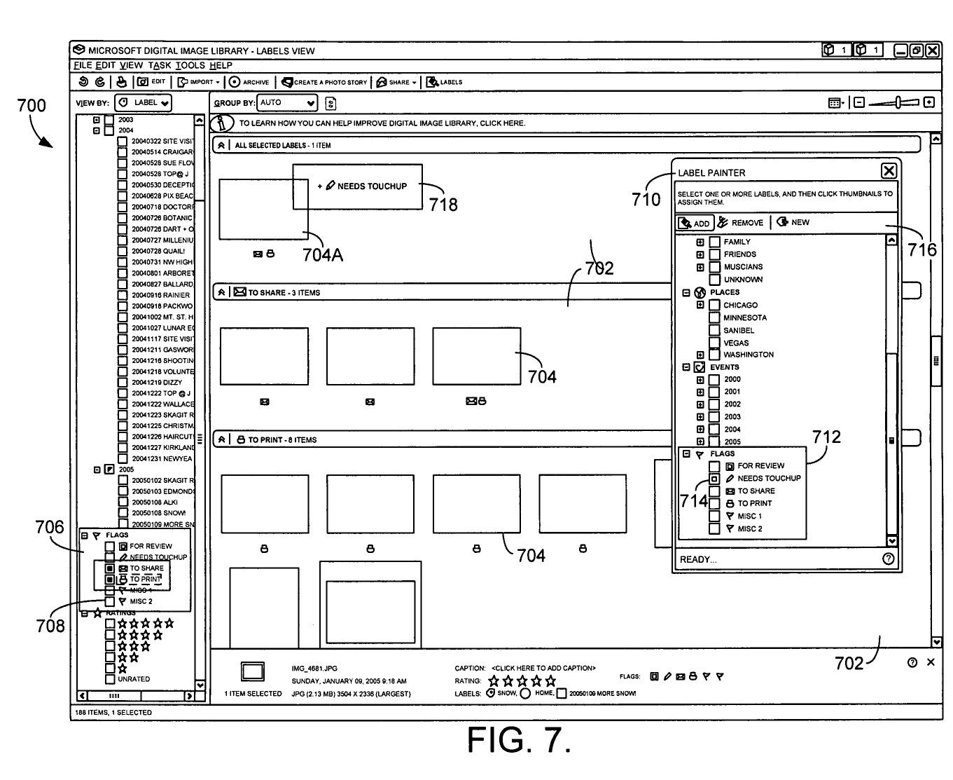

The user interface 600 of FIG. 6 illustrates another example of a control and shows that flags indicative of metadata representing one or more workflow-related actions may be associated with a particular image file by way of a ‘Label Painter’ function accessible from the ‘Tools’ drop-down menu. In this instance, a user may select the ‘Tools’ option from the toolbar followed by a ‘Label Painter’ option from the resulting drop-down menu. The user will then be presented with a ‘Label Painter’ dialog box, as shown in FIG. 7 and as more fully described below.

Thus, in the illustrated embodiment, a user has selected the ‘Tools’ option 610 from the toolbar 612. Selection of the ‘Tools’ option 610 caused display of a drop-down menu 614 having an ‘Label Painter’ option 616 thereon. Upon user selection of the ‘Label Painter’ option 616, a ‘Label Painter’ dialog box will be displayed, as shown in FIG. 7, illustrating the flags that are available for association with one or more image files, that is, the photographs associated with the thumbnails shown in the image file indicator display area 602.

Turning now to FIG. 7, a user interface 700 is shown which illustrates a ‘Label Painter’ dialog box 710 which may be utilized for manually associating metadata representing one or more workflow-related actions with one or more image files represented by photograph thumbnails 704 in an image file indicator display area 702. As previously mentioned, one way in which the ‘Label Painter’ dialog box 710 may be accessed is from the drop-down menu associated with the ‘Tools’ option on the toolbar, as shown in FIG. 6. The user interface 700 additionally includes a workflow-related indicator display area 706 configured to display one or more selectable workflow-related indicators 708. As with the user interface 300 of FIG. 3, the workflow-related indicators 708 of FIG. 7 may be utilized to query flags for one or more workflow-related actions a user desires or intends to perform, as more fully described below. Note that the image file indicator display area 702 is segregated into a plurality of different display sections, the significance of which is more fully described below with reference to FIG. 10.

The ‘Label Painter’ dialog box 710 includes a workflow-related indicator display area 712 configured to display one or more workflow-related indicators 714 capable of being associated with one or more image files and a selected action display area 716 indicating that a flag may be added or removed, or a new flag may be created on selection thereof. In this instance, a user may select a particular flag and/or its associated label, select the indicator (e.g., the thumbnail) associated with the image file with which he or she desires the flag to be applied, and select the ‘Add’ indicator from the selected action display area 716 to implement the flag application. Alternatively, the user may select the ‘Remove’ indicator from the selected action display area 716 to remove an existing flag, or the ‘New’ indicator to create a new flag.

Thus, in the illustrated embodiment, a user has selected the ‘Needs Touchup’ flag from the workflow-related indicator display area 712 and selected the thumbnail 704A for association therewith. Upon selection of the thumbnail 704A, an imminent action indicator 718 is displayed which indicates that the photograph associated with thumbnail 704A is going to be associated with the ‘Needs Touchup’ flag upon completion of the action. To implement the flag application, the user would select the ‘Add’ indicator from the selected action display area 716.

Turning now to FIG. 8, an additional user interface for manually associating metadata representing one or more workflow-related actions is shown and designated generally as reference numeral 800. The user interface 800 illustrates another example of a control in the form of a properties dialog box 802 accessible, for instance, upon selection of the ‘Properties . . . ’option 516 from the context menu 510 shown in FIG. 5.

The properties dialog box 802 includes a workflow-related indicator display area 804 configured to display one or more selectable workflow-related indicators capable of being associated one or more image files. In the illustrated embodiment, the properties dialog box 802 is image file-specific. That is, as the properties dialog box 802 has been accessed by selection of the ‘Properties . . . ’ option 516 from the context menu 510 shown in FIG. 5, which context menu 510 is specific to the particular image file(s) from which it was selected, the information provided by the properties dialog box 802 is specific to that image file(s). If any flags are associated with the image file in question, an indication of such would be indicated in the workflow-related indicator display area 804. In the illustrated embodiment, no flags are shown as associated with the subject image file.

If a user desires to associate one or more flags with the subject image file, he or she may select the desired workflow-related indicator from the workflow-related indicator display area 804, followed by selection of the ‘OK’ button 806. Selection of the ‘OK’ button 806 causes the properties dialog box 802 to be closed and the selected flag to be associated with the subject image file.

Turning now to FIG. 9, an additional user interface for manually associating metadata representing one or more workflow-related actions is shown and designated generally as reference numeral 900. The user interface 900 illustrates another example of a control in the form of a ‘Label Editor’ dialog box 902 accessible, for instance, upon selection of the ‘Edit Labels . . . ’ option 420 from the ‘Edit’ drop-down menu 411 of FIG. 4 or upon selection of the ‘Edit Labels . . . ’ option 520 accessible from the context menu 510 shown in FIG. 5.

The ‘Label Editor’ dialog box 902 includes a workflow-related indicator display area 904 configured to display one or more selectable workflow-related indicators 906 capable of being associated one or more image files. In the illustrated embodiment, there are six selectable workflow-related indicators 306 shown located within a node of a hierarchical tree structure, the node being designated by the term ‘Flags’. Two of the workflow-related indicators 906, those having the labels ‘To Share’ and ‘To Print’, indicate that all image files that were selected at the time the ‘Label Editor’ dialog box 902 was invoked have these flags associated therewith. Though not shown in the illustrated embodiment, if a plurality of image files were selected at the time the ‘Label Editor’ dialog box 902 was invoked but only a portion of those image files had a particular flag associated therewith, such flag would include an indicator as shown by reference numeral 908. Thus, it can be seen that the ‘Label Editor’ dialog box 902 may be invoked with respect to multiple image files simultaneously.

If a user desires to utilize the ‘Label Editor’ dialog box 902 to apply one or more flags to the selected image file(s), he or she may select the flag and/or label associated with the desired workflow-related indicator 906 and subsequently select the ‘OK’ button 910. Selection of the ‘OK’ button 910 causes the ‘Label Editor’ dialog box 902 to be closed and the selected flag(s) to be associated with the subject image file(s).

It will be understood and appreciated by those of ordinary skill in the art that a particular flag may be disassociated from a particular image file according to any one or more of the processes hereinabove described with respect to associating a flag with image file. Further, it will be understood that flags may be associated and/or disassociated with a plurality of image files in a batch-like fashion. That is, a plurality of image files may be selected simultaneously and subsequently have one or more flags applied thereto or removed therefrom. All such variations are contemplated to be within the scope hereof.

In addition to being received based upon manual user input, metadata may be obtained upon automatic determination by the image file organization application itself. In this instance, once an image file is received, metadata representing one or more workflow-related actions may be automatically associated with the image file without further action being taken by a user. For instance, in one embodiment, the application may determine upon receipt of a particular photograph image file that underexposure or overexposure has occurred and, accordingly, automatically flag the photograph for editing. In another embodiment, a user may establish a set of predefined rules that the application will automatically apply upon receipt of an image file. For instance, the user may establish that every time a new photograph is received, it is to be marked for editing or review. Accordingly, upon receipt of a new photograph, the application will automatically apply the editing flag to the photograph.

Similarly, metadata may be automatically dissociated from a particular image file according to one or more predefined criteria without further action by a user. For instance, if a ‘To Print’ indicator is associated with a particular image file, once the action has been completed (i.e., once the image file has been printed) the indicator may be automatically dissociated without further user action required.

It will be understood by those of ordinary skill in the art that the delineated embodiments are exemplary only and are not intended to limit the scope of the invention in any way. All variations wherein the image file organization application automatically associates workflow-related metadata with an image file upon receipt thereof or dissociates workflow-related metadata according to one or more predefined criteria without further action by a user are intended to be within the scope of the present invention.

With reference back to FIG. 2, however obtained, the subjective metadata associated with the received image file is subsequently stored in a database in association with the image file, as indicated at block 214.

A user may utilize the workflow-related metadata associated with one or more image files to organize image files into collections based upon a specific action he/she desires or intends to take with respect to such image files. That is, once flags have been applied to one or more image files (whether manually by user action or automatically by the system), a user may optionally query the application to retrieve all image files that are associated with particular workflow-related metadata. A user interface for receiving such a user query with respect to photograph files is illustrated in FIG. 10, which user interface is more fully described below.

Upon receipt of a user query indicative of one or more workflow-related actions, the query is processed, as indicated at block 216 of FIG. 2. Subsequently, the image file or image files that have been associated with the one or more workflow-related actions are retrieved in response to the query, as indicated at block 216, and an indicator (e.g., a thumbnail) thereof displayed, as indicated at block 220. Note that if no image files have been associated with the user queried workflow-related action(s), an indication of such may be displayed rather than the retrieved image file indicators (thumbnails) as shown.

Turning now to FIG. 10, a user interface for receiving a user query and displaying the results thereof is illustrated and designated generally as reference numeral 1000. The user interface 1000 of FIG. 10 is specific to photograph file formats. It will be understood by those of ordinary skill in the art, however, that a similar user interface having complementary illustrated features may be utilized for other image file formats, e.g., video files, and the like. All such variations are contemplated to be within the scope hereof.

The user interface 1000 includes an image file indicator display area 1002. The image file indicator display area 1002 is segregated into a plurality of display segments 1002A, 1002B, and 1000C, the significance of which is more fully described below. The image file indicator display area 1002 is configured to display one or more selectable image file indicators 1004, e.g., thumbnail indicators, of the image files represented thereby. The user interface 1000 further includes a workflow-related indicator display area 1006 configured to display one or more selectable workflow-related indicators 1008. In the illustrated embodiment, there are six selectable workflow-related indicators 1008 shown located within a node of a ‘View By’ hierarchical tree structure, the node being designated by the term ‘Flags’. The six workflow-related indicators shown are identical to those hereinabove described with reference to FIG. 3.

Selection of one or more of the workflow-related indicators 1008 provides a query to the image file organization application to retrieve all image files to which the selected indicator or indicators has been applied. In the illustrated example, the workflow-related indicators 1008 ‘To Share’ and ‘To Print’ have both been selected by a user. In response to the query, all photographs having one or both of the ‘To Share’ and ‘To Print’ flags applied thereto are retrieved by the system and displayed in the image file indicator display area 1002.

A couple of items shown in the image file indicator display area 1002 are worthy of note. First, the image file indicator display area is segregated into three separate display segments 1002A, 1002B, and 1002C. The image file indicators shown in display segment 1002A are those image files which have both the ‘To Share’ flag and the ‘To Print’ flag associated therewith. The image file indicators shown in display segment 1002B are those image files which have only the ‘To Share’ flag associated therewith. And the image file indicators shown in display segment 1002C are those image files which have only the ‘To Print’ flag associated therewith. In this way, a user may query multiple workflow-related indicators simultaneously while still being able to determine which indicators are associated with which image files.

The second item worthy of note is that a single image file which is associated with multiple workflow-related indicators may be displayed in each display segment to which it belongs. For instance, photograph ‘A’ includes both the ‘To Share’ and ‘To Print’ flags associated therewith. As such, photograph ‘A’ is displayed in each of display segments 1002A, 1002B, and 1002C. In this way, a single image file may be included as part of any number of image file collections and inclusion in one collection does not result in exclusion from another.

As briefly mentioned above with regard to the ‘Misc 1’ and ‘Misc 2’ workflow-related indicators, the flags and/or labels associated with the workflow-related indicators described herein may be modified by a user, as desired. A user interface for modifying the flag and/or label associated with a workflow-related indicator is illustrated in FIG. 11 and designated generally as reference numeral 1100. The user interface 1100 of FIG. 11 is specific to photograph image file formats. It will be understood by those of ordinary skill in the art, however, that a similar user interface having complementary illustrated features may be utilized for other image file formats, e.g., video files, and the like. All such variations are contemplated to be within the scope hereof.

The user interface 1100 includes a image file indicator display area 1102 configured to display one or more selectable image file indicators 1104. To edit one or more flags associated with the image file indicators, a user may select the ‘Edit’ option 1106 from the toolbar 1108, selection of which causes display of a drop-down menu associated therewith. Subsequently, the user may select the ‘Assign Flag’ option 1100 from the drop-down menu which causes display of an additional drop-down menu having an ‘Edit Flags . . . ’ option 1112 thereon. Selection of the ‘Edit Flags . . . ’ option 1112 results in display of an ‘Edit Flags’ dialog box 1114.

It should be noted that the ‘Edit Flags’ dialog box 1114 may additionally be accessed by selection of the ‘Edit Flags . . . ’ indicator 518 in the second workflow-related indicator display area 514 of FIG. 5 or the ‘Edit Flags . . . ’ indicator 618 in the drop-down menu 614 of FIG. 6.

The ‘Edit Flags’ dialog box 1114 includes a flag 1117 and associated label 1118 for each of the workflow-related indicators that are available for association with the image file indicators 1104 displayed in the image file indicator display area 1102. Each of the flags 1117 and the associated labels 1118 may be independently modified. To modify one or more of the flags, a user may select the down arrow located next to each flag 1117, selection of which causes display of a flag selection options menu 1116. If a user desires to modify a flag associated with the workflow-related indicator, he or she may simply select a different flag from the flag selections options menu 1116 than the one currently associated therewith. If a user desires to modify a label associated with a particular flag, he or she may simply erase the text indicating the currently associated label and replace it with the text of his or her choice. Subsequent to making any desired modifications, the user may select the ‘OK’ button 1120, selection of which causes the ‘Edit Flags’ dialog box 1114 to close and any modifications made to be implemented.

It should be noted that additionally included in the ‘Edit Flags’ dialog box 1114 is an option to ‘Show Flags On Thumbnails’ 1124. If this option is selected, the flags that are associated with the workflow-related indicators associated with a particular image file will be displayed in association therewith. An example of this is illustrated in FIG. 3 as flag overlay 314. If not selected, flags will not be shown in the image file indicator display area 1102 (302 of FIG. 3) in association with the image files to which they have been applied.

An additional flag that may be applied to one or more image file indicators in accordance with an embodiment of the present invention is a privacy flag. Application of a privacy flag to one or more image files will prevent the associated image file(s) (e.g., photograph(s)) from being displayed in slideshows and/or screensavers that typically display all image files that are a part of a particular collection. In the illustrated embodiment, a privacy flag may be applied to one or more image files upon disassociation of a default option. Such disassociation may be applied by selection of the ‘Show in Slideshows’ indicator 422 of FIG. 4, the ‘Show in Slideshows’ indicator 522 of FIG. 5, the ‘Show in Screen Savers and Slideshows’ indicator 808 of FIG. 8, or the ‘Show in Slideshows’ indicator 1122 of FIG. 11.

In each of these instances, the indicated option is selected by default indicating that without affirmative user action to disassociate the default option, the image file will be shown in slideshows and screen savers that access image files from one or more collections of which the image file is a part. To apply the privacy flag, the default option may be disassociated by a user.

Note also that as the image file organization application undertakes a particular action with regard to the privacy flag, such flag and/or the associated label is not capable of being modified like the other flags/labels hereinabove described. It will be understood and appreciated by those of ordinary skill in the art that a distinction between the privacy flag and the other flags is made herein by way of example only and is not intended to limit the particular workflow-related actions associated with any of the flags described herein. That is, if the image file organization application is configured to undertake a particular action with regard to any other flag, for instance, the ‘To Print’ flag, such flag may be treated in the manner which is described herein with regard to the privacy flag. Alternatively, if the image file organization application is configured such that particular action is not taken with regard to the privacy flag without additional user action, the privacy flag may be treated in the manner which is described herein with regard to the other flags. The particular delineation illustrated herein is intended only to illustrate that flags having predefined functions associated therewith and flags that are merely designed as a search and display tool for users are both contemplated by and intended to be within the scope of the present invention.

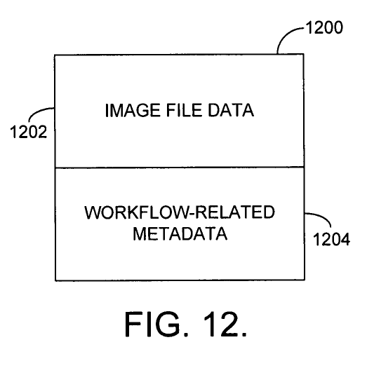

Embodiments of the present invention further relate to one or more computer-readable media having stored thereon a data structure including a number of fields. With reference to FIG. 12, a schematic diagram illustrating a data structure in accordance with an embodiment of the present invention is illustrated and designated generally as reference numeral 1200. The data structure 1200 includes a first field 1202 containing data representing one or more image files (e.g., photograph files, video files, and the like) and a second field 1204 containing metadata representing one or more workflow-related actions capable of being associated with the data contained in the first field.

As can be understood, embodiments of the present invention provide methods and systems that permit a user to associate metadata representing one or more workflow-related actions with at least one image file, e.g., a photograph file, a video file, or the like. Workflow-related actions describe one or more actions which may be undertaken with respect to an associated image file. For instance, workflow-related actions may include, by way of example only, printing, editing, reviewing, sharing, deleting, and the like.

Once associated with metadata representing one or more workflow-related actions, an image file may be retrieved based upon a query for at least one of the associated workflow-related actions. If more than one workflow-related action is represented in the metadata associated with the image file, the image file may be retrieved based upon a query for each workflow-related action individually or multiple workflow-related actions concurrently.

Workflow-related actions are dynamic by nature, that is, they are likely to change over time as actions are undertaken with respect to a particular image file. Thus, the methods and systems of the present invention facilitate the organization of image files based upon dynamic subjective metadata. Such organization facilitates the efficient treatment of image file collections.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A method for organizing image files based upon workflow, comprising:
receiving at least one image file;
obtaining metadata to be associated with the at least one image file, the metadata representing a workflow-related action; and
storing the at least one image file in association with the metadata.

2. The method of claim 1, wherein receiving at least one image file comprises receiving at least one photograph.

3. The method of claim 1, wherein obtaining metadata to be associated with the at least one image file comprises receiving the metadata via user input.

4. The method of claim 1, wherein obtaining metadata to be associated with the at least one image file comprises obtaining metadata representing a plurality of workflow-related actions.

5. One or more computer-readable media having computer-executable instructions for performing the method of claim 1.

6. The method of claim 1, further comprising:
processing a query indicative of the workflow-related action; and
displaying the at least one image file in response thereto.

7. One or more computer-readable media having computer-executable instructions for performing the method of claim 6.

8. The method of claim 1, further comprising:
obtaining an indication that the metadata is to be disassociated from the at least one image file; and
disassociating the metadata from the at least one image file.

9. The method of claim 8, wherein obtaining an indication that the metadata is to be disassociated from the at least one image file comprises receiving the indication via user input.

10. One or more computer-readable media having stored thereon a data structure, comprising:
a first field containing data representing a first image file; and
a second field containing metadata representing a workflow-related action capable of being associated with the data representing the first image file.

11. The one or more computer-readable media of claim 10, wherein the first field of the data structure contains data representing a first photograph.

12. The one or more computer-readable media of claim 10, wherein the first field further contains data representing a second image file, and wherein the metadata representing the workflow-related action contained in the second field is capable of being associated with the data representing the first image file and the data representing the second image file.

13. The one or more computer-readable media of claim 10, wherein the second field further contains data representing a plurality of workflow-related actions each of which is capable of being associated with the data representing the first image file.

14. A user interface for organizing image files based upon workflow, comprising:
an image file indicator display area configured to display a selectable image file indicator; and
a workflow-related indicator display area configured to display a selectable workflow-related indicator capable of being associated with the selectable image file indicator.

15. The user interface of claim 14, wherein the image file indicator display area is configured to display a selectable photograph indicator.

16. The user interface of claim 14, further comprising a control for associating the selectable workflow-related indicator with the selectable image file indicator.

17. The user interface of claim 15, wherein the control associates the selectable workflow-related indicator with the selectable image file indicator in response to user input.

18. The user interface of claim 14, wherein if the workflow-related indicator is associated with the image file indicator, the image file indicator display area is further configured to display the selectable image file indicator in association the selectable workflow-related indicator.

19. The user interface of claim 14, wherein the workflow-related indicator display area is further configured to display a plurality of selectable workflow-related indicators capable of being associated with the selectable image file indicator.

20. The user interface of claim 19, wherein if one or more of the plurality of workflow-related indicators is associated with the image file indicator, the image file indicator display area is further configured to display the selectable image file indicator in association with each of the plurality of workflow-related indicators associated therewith.
